(19) United States
(12) Patent Application Publication
(10) Pub. No.: US 2025/0203006 A1
(43) Pub. Date: Jun. 19, 2025

(54) INTENT-BASED DETECTION AND RESPONSE SYSTEM FOR VOICE CALL PHISHING

(71) Applicant: Cisco Technology, Inc., San Jose, CA (US)

(72) Inventors: Jason Coleman, Hendersonville, NC (US); Christopher Scott Dozier, Raleigh, NC (US); Steven Michael Holl, Sarasota, FL (US); Aman Sardana, Morrisville, NC (US); Jason Kuhne, Hopkinton, MA (US)

(21) Appl. No.: 18/540,598

(22) Filed: Dec. 14, 2023

(51) Int. Cl. H04M 3/22; G10L 15/18

(52) U.S. Cl. CPC H04M 3/2281; G10L 15/1822; H04M 2203/6027

(57) ABSTRACT

In some embodiments, a method includes receiving first audio data provided via a first device of a first user during a call session between the first device and a second device of a second user, receiving second audio data provided via the second device during the call session, providing the first audio data and/or the second audio data to a large language model (LLM) to determine an intent of the first user, and transmitting a control message in response to determining the intent of the first user is associated with soliciting sensitive information from the second user.

### TECHNICAL FIELD

The present disclosure relates to voice call phishing.

### BACKGROUND

Call sessions are used to allow individuals to communicate with one another from different locations. A call session includes transmission of audio and may also include transmission of video (e.g., for a video call session). Unfortunately, a call session may establish connection to a malicious entity, such as an unauthorized caller. The malicious entity may attempt to solicit information from the individual, such as personal or confidential information (e.g. company trade secrets) or other information that otherwise may not be intended to be provided to the malicious entity. For example, the malicious entity may perform voice phishing, or vishing, by posing as a different entity, such as a trustworthy user (e.g., law enforcement), a person (e.g., a relative, a friend) recognized by the individual, and/or an employer, to manipulate the individual to unintentionally provide information to the malicious entity during the call session. As a result, the malicious entity may obtain information, and such information may be used to perform various unauthorized or unintended actions that are detrimental to the individual and/or to an organization associated with the individual, such as by accessing the individual's credentials to a private or privileged resource.

### BRIEF DESCRIPTION OF THE DRAWINGS

FIG. 1A is a schematic diagram of a vishing defense system illustrating potential actions to detect, notify, report, defend, and/or learn from a potential vishing attack, according to an example embodiment.

FIG. 1B is a block diagram of an operation of the vishing defense system of FIG. 1A to detect and mitigate a vishing attack intent, according to an example embodiment.

FIG. 1C is a block diagram of an operation of the vishing defense system of FIG. 1A to censor audio, according to an example embodiment.

FIG. 2 is a schematic diagram of a vishing defense system using an integrated processor, according to an example embodiment.

FIG. 3 is a schematic diagram of another vishing defense system using an intermediate device, according to an example embodiment.

FIG. 4 is a schematic diagram of yet another vishing defense system using a server that captures media packets, according to an example embodiment.

FIG. 5 is a flowchart of a method for addressing a potential vishing attack, according to an example embodiment.

FIG. 6 is a flowchart of another method for addressing a potential vishing attack, according to an example embodiment.

FIG. 7 is a flowchart of yet another method for addressing a potential vishing attack, according to an example embodiment.

FIG. 8 is a flowchart of still another method for addressing a potential vishing attack, according to an example embodiment.

FIG. 9 is a hardware block diagram of a device that may be configured to perform operations involved in addressing a potential vishing attack, according to an example embodiment.

### DETAILED DESCRIPTION

### Overview

In one embodiment, a method is provided that includes: receiving first audio data provided via a first device of a first user during a call session between the first device and a second device of a second user; receiving second audio data provided via the second device during the call session; providing the first audio data and/or the second audio data to a large language model (LLM) to determine an intent of the first user; and transmitting a control message in response to determining the intent of the first user is associated with soliciting sensitive information from the second user.

### Example Embodiments

A call session is used to communicatively connect individuals to one another, such as individuals located at different locations. During the call session, the devices of the individuals are connected to enable the individuals to speak to one another in real time. The devices may also enable the individuals to see one another, such as through a video call. Thus, the call session may help the individuals to interact with one another as if the individuals were in each other's presence.

Unfortunately, a malicious entity may also use a call session to try to solicit certain information from an individual. As an example, the malicious entity may use a vishing technique in which the malicious entity may impersonate a more trustworthy entity to gain the trust of the individual and manipulate the individual into providing the information. For instance, the malicious entity may emulate the voice of the trustworthy entity to provide a realistic and convincing imitation of the trustworthy entity. Since the individual and the malicious entity may be at different locations, it may be difficult for the entity to verify the identity of the malicious entity. Thus, the malicious entity may more easily convince the individual and cause the individual to unintentionally provide information. The malicious entity may then utilize the information in a manner that may negatively affect the individual, such as by logging into a user account of the individual. As a second example, a person may try to socially engineer a target, using conversational techniques such as developing rapport, persuading, escalating, and/or exploitation to extract sensitive information from the victim.

For this reason, it is desirable to address and defend against vishing to improve the wellbeing of individuals and/or the organization/enterprise supported by an individual. Thus, embodiments of the present disclosure are directed to systems and methods to prevent, minimize, reduce, or at least discourage unintentional transfer of information to malicious entities over call sessions via vishing. By way of example, audio data exchanged between users during a call session may be analyzed to determine an intent of one of the users. In response to a determination of the intent being associated with solicitation of sensitive information or detection of actual exploitation of sensitive information, an additional operation may be performed to address or mitigate the intent.

As an example, a notification (e.g., an audio notification) may be output, such as inter-mixed within the in-band audio stream, to inform the recipient or another interested party (e.g., a supervisor of the recipient) and/or to dissuade the recipient in real-time from providing any sensitive information, similar to a live-call whisper notification in a contact center. As another example, audio data that originally included sensitive information may be modified or redacted such that the sensitive information is removed or replaced (e.g., with noise or a bleep) to obfuscate the sensitive information. Thus, the sensitive information may not be provided upon transmission of the modified audio data. In some embodiments, this may be achieved by extending the playout buffer on the digital signal processor to a duration such that the speech to text conversation and LLM have a sufficient amount of time to process the audio and intent in real time before the original speech is delivered back to the attacker. As a further example, after detection of a successful attack and identification of producing sensitive information, a user account associated with the sensitive information may be modified to block access to the user account and/or reduce effectiveness of the sensitive information with respect to the user account. Further still, the identity of a user may be authenticated to determine whether a potential vishing attack is occurring. For example, in response to a determination that the identity of the user cannot be authenticated, thereby indicating the user may be impersonating another entity, an attempted vishing attack may be identified to cause an additional operation to be performed. In this manner, one of multiple different operations may be performed (e.g., selectively performed) in response to the identified intent associated with solicitation of sensitive information to address vishing.

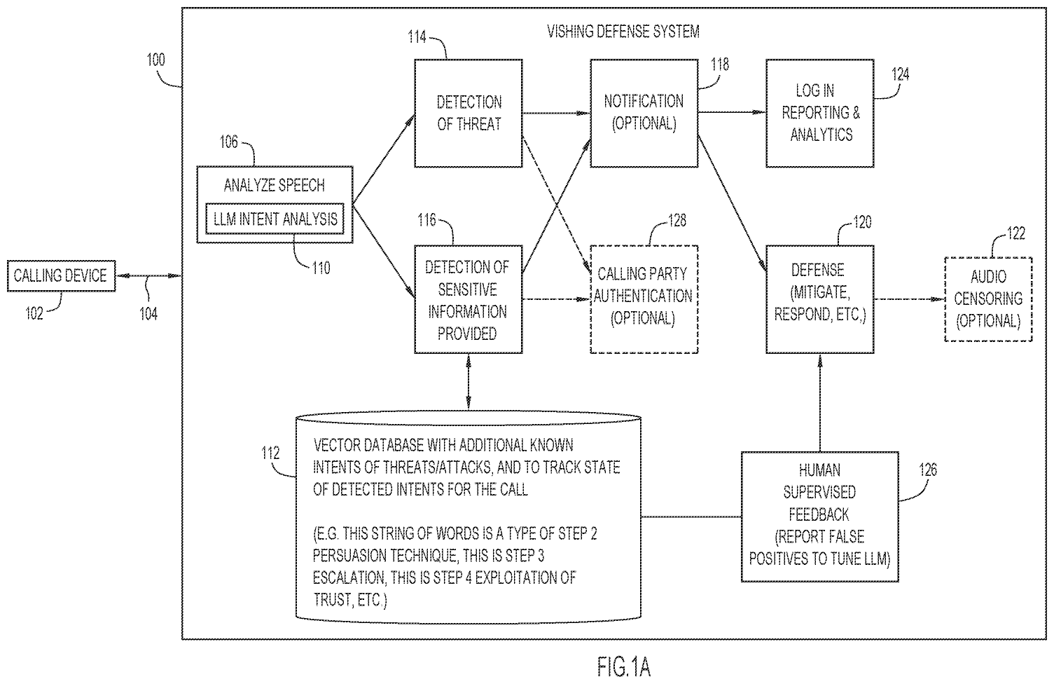

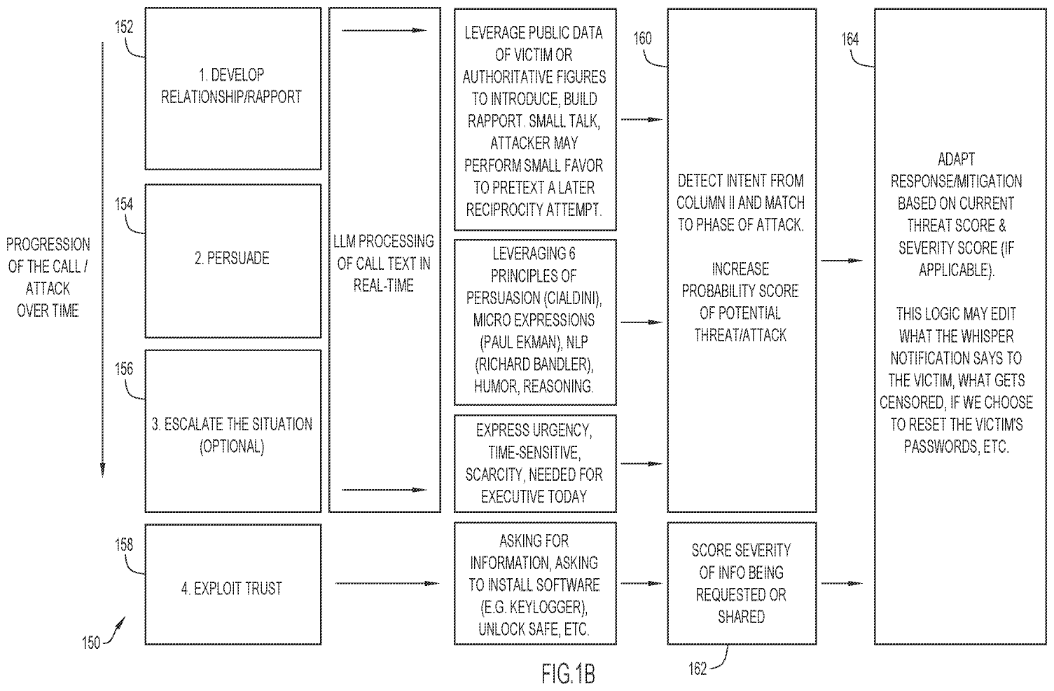

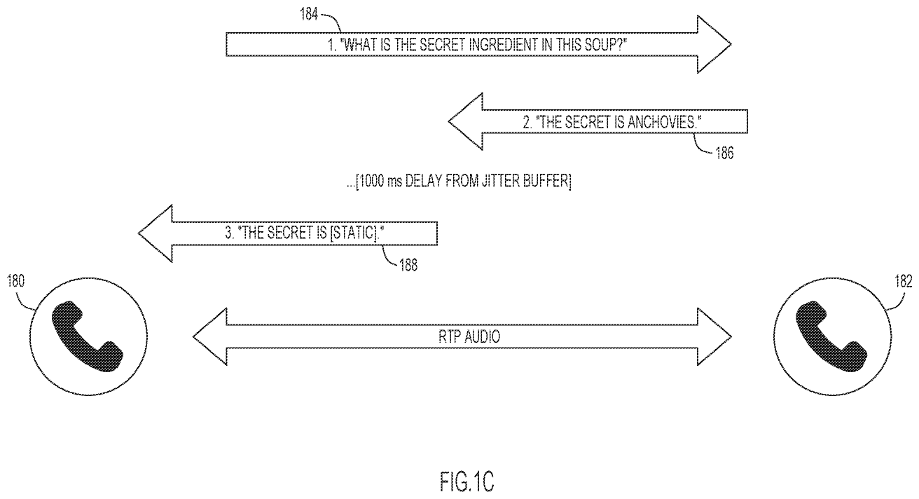

With the preceding in mind, FIG. 1A illustrates a schematic diagram of a vishing defense system 100, which may be used by an individual, an organization, and/or a company. The vishing defense system 100 may include a variety of components and devices, such as a mobile phone, a landline phone, a laptop computer, a tablet, a desktop computer, a printed circuit board, a server device, and so forth. The vishing defense system 100 may be configured to communicatively couple to a caller/calling device 102, such as another mobile phone, another laptop computer, another tablet, another desktop computer, and the like, used by a potential malicious entity. Thus, a first entity (e.g., a first person) may use the caller device 102 to speak to a second entity (e.g., a second person) that has the vishing defense system 100 enabled or integrated. Although the present disclosure primarily discusses the malicious entity being a caller and the vishing defense system 100 operating for a recipient with respect to the caller, it should be noted that the malicious entity may be a recipient and/or the vishing defense system 100 may operate for a caller in additional or alternative embodiments. That is, the vishing defense system 100 and the caller device 102 may have any suitable caller-recipient relationship.

During a call session in which the caller device 102 is communicatively coupled to the vishing defense system 100, the vishing defense system 100 may receive audio data 104 exchanged between the caller device 102 and the vishing defense system 100, such as dialogue spoken by the people using the vishing defense system 100 and the caller device 102, respectively. The vishing defense system 100 may then perform various operations based on the audio data 104. For example, at a first step 106, speech of the audio data 104 may be analyzed. In some embodiments, the audio data 104 may be converted to textual word sets, and the text may be analyzed to determine the content. Based on the content of the speech, at a sub-step 110, an intent is determined. In some embodiments, one or more large language models (LLMs) are used to determine the intent. The LLM(s) may additionally utilize stored datasets (e.g., stored datasets, embeddings) from a database (e.g., a vector database) to improve classification of the intent and the detection of a vishing attack, as well as to track a state of a conversation as a vishing attack intent is detected throughout the life of a call session. Portions of the audio data 104 are labeled accordingly to determine the intent. That is, the labels of different portions of the audio data 104 may indicate the overall intent. Thus, the intent may be determined based on the labels, such as a change in the labels and/or a presence of different combinations/permutations of labels during a call session. The LLM(s) may enable the vishing defense system 100 to operate readily without any prior training or knowledge of an attack pattern. In other words, the vishing defense system 100 may operate using the LLM(s) without having to train against a reference source of vishing attacks, such as previous example calls of vishing attacks. Thus, the LLM(s) may increase efficient operation and implementation of the vishing defense system 100 (e.g., as compared to pre-trained machine learning models).

At a second step 114, the intent of a vishing attack may be detected (e.g., based on the labels of the audio data 104). For example, the intent of a vishing attack may be detected prior to the caller explicitly asking for sensitive information and/or prior to sensitive information being divulged to the caller. Thus, the intent may be detected as an early warning to cause intervention before the impact of providing sensitive information may be effective. Additionally, or alternatively, at a third step 116, provision of sensitive information is detected. For instance, the vishing defense system 100 may detect an intent to extract personal information (e.g., family history, identification information), organization information (e.g., trade secrets, confidential product information, login credentials), and so forth. In certain embodiments, the threshold reached to cause detection of the intent of a vishing attack and/or detection of the provision of sensitive information may be adjustable. That is, the amount of similarity matched between the audio data 104 and characteristics of vishing attack intents may be adjustable to define when a vishing attack a provision of sensitive information is detected. For example, certain users may have less tolerance for false positives. Thus, the threshold for such users may be increased to reduce the possibility of falsely detected intents of a vishing attack and/or falsely detected provisions of sensitive information. In some implementations, the threshold can be modified dynamically, such as based on a determination regarding whether the calling party authenticated (e.g., based on whether the calling party uses a calling number that is authenticated). In such an example, the threshold for detecting an intent of a vishing attack may lower compared to the threshold applied for an authenticated.

At a fourth step 118, a notification may be provided in response to a detection of the intent of a vishing attack and/or in response to a detection of the provision of sensitive information. In some embodiments, the notification may be provided by generating audio data and providing the audio data (e.g., as a one-way in-band audio message) via the device used by the recipient for the call session, such as in addition to or as an alternative to the audio data provided via the caller device 102 to notify the recipient of a potential attack. In additional or alternative embodiments, the notification may be provided via a visual, audible, or haptic output to a device, such as on a desktop computer or a laptop computer, that is not directly used by the recipient for the call session. Out of band notifications, such as a text message, may also be employed to notify the recipient, such as a recipient that utilizes notifications for a wearable device separate from but corresponding to the caller device 102. In either case, the notification may be easily observed by the recipient, such as in comparison to providing a visual output and/or haptic feedback to the device used by the recipient for the call session (e.g., because it may be difficult to observe the visual output and/or haptic feedback of such a device while also using the device for the call session). The notification may inform or warn the recipient of the potential vishing attack and cause the recipient to be more cautious during conversation with the caller, to disconnect the call session, or otherwise discourage the recipient form providing sensitive information. In further embodiments, a notification may be provided to another user, such as a supervisor of the recipient, a family/friend of the recipient, law enforcement, a compliance group, human resources, and so forth, to prompt the other user to take additional action.

At a fifth step 120, a defensive operation may be performed. Such a defensive operation may include mitigating or responding to the vishing attack and/or to the provision of sensitive information, and the defensive operation may be based on the specific detection. By way of example, at a sixth step 122, in response to the determination that sensitive information is being provided by the recipient, the vishing defense system 100 may censor such sensitive information. That is, the vishing defense system 100 may modify audio data to remove speech provided by the recipient that may include the sensitive information (e.g., by dropping or obfuscating audio frames containing the sensitive information). Thus, the audio data provided to the caller device 102 may not include the sensitive information. As a result, the caller does not successfully receive the sensitive information, even though the recipient had intended to provide such sensitive information to the caller device 102. Other examples of a defensive operation may include modifying/locking a user's account (e.g., in response to determining a user's login credentials were successfully provided to the caller device 102), blocking audio data transmission from the caller device 102 (e.g., thereby hindering the caller from trying to manipulate the recipient), disconnecting the call session, blocking future calls from the caller device 102, and the like. In this manner, a more suitable action may be performed to address a potential vishing attack. In any of these embodiments, a small buffer or playout delay (e.g., one or two seconds) may be implemented between transmission of audio data and receipt of audio data with respect to the caller device 102 and the recipient device to provide sufficient time that may enable the vishing defense system 100 to analyze the audio data 104 and perform a suitable operation, such as by modifying or redacting the audio data 104.

In further embodiments, a threat or impact score may be determined based on the audio data 104 at the second step 114 and at the third step 116, respectively, and a particular defensive operation may be performed at the fifth step 120 based on the threat or impact score. The threat score may indicate the likelihood of the audio data 104 being associated with a vishing attack (e.g., a higher threat score may indicate the caller is more likely attempting to solicit sensitive information from the recipient), and the impact score may indicate the potential importance of the sensitive information being provided (e.g., a higher impact score may indicate the sensitive information is more important and to be protected with greater security). The defensive operation may then be selected based on the score. For instance, a relatively more drastic (e.g., and potentially more effective) defensive operation may be performed based on a higher score. As an example, for a lower score, a notification may be output. For an intermediate score, audio data transmission from the caller device 102 may be blocked. For a higher score, the call session may be disconnected. Thus, the action being performed may be more appropriate.

At a seventh step 124, the exchange of audio data (e.g., as well as video or screen recording data in the event of a screen sharing session) between the caller and the recipient may also be recorded/stored for analysis. Samples of the attack (e.g., redacted sampled with sensitive information removed) may be stored at (e.g., at a central database accessible by multiple other vishing defense systems 100) for further analysis, such as to fine-tune detection capability. For instance, at an eighth step 126, the dataset stored in the database 112 may be adjusted based on the audio data using human supervised feedback (e.g., analysis manually performed by a user). As an example, in response to the human supervised feedback indicating a correct detection of a vishing attack intent and/or a correct detection of provision of sensitive information, the dataset stored in the database 112 may be reinforced to facilitate further detection of a subsequent vishing attack intent and/or a subsequent provision of sensitive information based on similar audio data. As another example, in response to the human supervised feedback indicating an incorrect detection of a vishing attack intent and/or an incorrect detection of provision of sensitive information, the dataset stored in the database 112 may be adjusted to avoid detection of a subsequent vishing attack and/or a subsequent provision of sensitive information based on similar audio data. Therefore, the database 112 may be updated to facilitate analysis of subsequent audio data for more accurate detections.

In some embodiments, at a ninth step 128, an operation may be performed to authenticate the caller in response to detection of the potential vishing attack and/or of the provision of sensitive information. As discussed, during a vishing attack, the caller may impersonate another entity to manipulate the recipient. Thus, authentication of the caller may be performed to verify the identity of the caller and determine whether the caller is potentially impersonating another entity to suggest a possible vishing attack. By way of example, during authentication of the caller, properties of the voice of the caller, such as tone, timbre, pitch, volume, rate, and so forth, may be determined from the audio data 104. Such properties may be compared to expected or known voice properties (e.g., properties previously provided or determined, such as during enrollment of the voice of known/trusted users into the vishing defense system 100) of the supposed identity of the caller to determine whether the voice of the caller indicates the caller matches the identity. For example, based on the audio data 104, the vishing defense system 100 may determine that the caller indicates their identity is a work supervisor of the recipient. The vishing defense system 100 may then select stored voice properties associated with the work supervisor and compare the stored voice properties associated with the work supervisor with determined voice properties of the audio data 104 provided by the caller. Based on a match between the stored voice properties and the determined voice properties, the vishing defense system 100 may verify the identity of the caller is the work supervisor. However, based on a mismatch between the stored voice properties and the determined voice properties, the vishing defense system 100 may determine the identity of the caller is not the work supervisor. The vishing defense system 100 may also authenticate the caller to verify the identity of the caller using any other suitable technique, such as by transmitting an authentication code to a known device associated with the identity (e.g., to prompt the supposed caller to verify receipt of the authentication code) and/or by determining an identification of the caller device 102 (e.g., to verify a known or expected device is being used by the caller).

In any case, in response to a determination that the identity of the caller is not successfully authenticated, indicating the caller may be impersonating another identity, a defensive action, such as that of the fifth step 120, may be performed to avoid an unintentional exchange of sensitive information. In response to a determination that the identity of the caller is successfully authenticated, indicating the identity of the caller may be verified (e.g., the caller may not be impersonating another identity), no further action may be performed. For example, the intent of the caller to solicit sensitive information and/or the provision of sensitive information to the caller may be safe and authorized. Thus, the conversation between the caller and the recipient may not be further addressed to enable the safe exchange of sensitive information.

FIG. 1B is a block diagram illustrating operations of the vishing defense system 100 related to detecting an intent of a vishing attack (e.g., the sub-step 110). As discussed herein, the vishing defense system 100 may label portions of the audio data 104 during a call session and detect an intent based on the labels. In the illustrated embodiment, an intent of a vishing attack is detected with reference to a vishing attack anatomy 150. In particular, the vishing attack anatomy 150 includes a first label 152, a second label 154, a third label 156, and a fourth label 158. An intent of a vishing attack may be determined upon sequentially labeling portions of the audio data 104 with the labels 152, 154, 156, 158. That is, progression of detecting the labels 152, 154, 156, 158 in the audio data 104 may cause the intent of a vishing attack to be detected.

The first label 152 may be associated with developing relation/rapport with an individual. As an example, discussion unrelated to sensitive information (e.g., small talk associated with personal topics) may be attempted. As another example, an action or favor benefiting the individual may be performed to manipulate the individual for reciprocity. Thus, the first label 152 may be determined based on various detections of mutual conversational exchanges. The second label 154 may be associated with persuading an individual. The detection of the second label 154 may be performed with reference to various models related to persuasion. The third label 156 may be associated with escalation and may be detected based on a sense of urgency invoked by the potential attacker. The fourth label 158 may be associated with exploiting trust and may be detected based on a request for information, such as sensitive information.

By way of example, a set of words of the audio data 104 may be labeled as an attempt to develop rapport, a subsequent set of words of the audio data 104 may be labeled as a persuasion attempt, a subsequent sentence of the audio data 104 may be labeled as an escalation attempt, and a subsequent set of sentences of the audio data 104 may be labeled as an attempt at exploiting for information). An intent of a vishing attack may then be determined upon such labeling of the audio data 104. By detecting the labels and monitoring the state/changes of the labels 152, 154, 156, 158 (e.g. progression along the vishing attack anatomy 150, what labels 152, 154, 156, 158 associated with a vishing attack technique has been attempted throughout a call session), the vishing defense system 100 can identify when the intent may have similarity to being a vishing threat. Furthermore, through human reinforcement, the intent detection of vishing attacks may be improved, such as by determining new persuasion techniques, thereby allowing for improved accuracy in real time (e.g., in response to new vishing attack techniques).

A corresponding action may then be performed based on the labels 152, 154, 156, 158. For example, in response to detection of (e.g., progression through) each of the labels 152, 154, 156, a score indicating probability of an intent of a vishing attack may be increased, as shown at step 160. In response to detection of the fourth label 158, a score indicating provision of sensitive information may be determined, as shown at step 162. For each score, an action may be selectively performed to mitigate or otherwise address the vishing attack, as shown at step 164. As an example, an audio notification may be output based on the score indicating the probability of an intent of a vishing attack, whereas a user's account may be adjusted based on the score indicating the provision of sensitive information.

FIG. 1C is a block diagram illustrating operations of the vishing defense system 100 related to censoring audio (e.g., the sixth step 122) exchanged between a first caller device 180 (e.g., a device used by an attacker intending to perform a vishing attack) and a second caller device 182 (e.g., a device used by a victim of a vishing attack). That is, the vishing defense system 100 may detect sensitive information is being provided, and the vishing defense system 100 may censor the sensitive information in response.

For example, first audio data 184 may be provided via the first caller device 180. The vishing defense system 100 may analyze the first audio data 184 and label the first audio data 184 with the fourth label 158 associated with exploiting trust. Second audio data 186 may then be provided via the second caller device 182 to respond to the first audio data 184. The vishing defense system 100 may analyze the second audio data 186 and determine sensitive information contained in the second audio data 186. As an example, the vishing defense system 100 may associate a set of words of the second audio data 186 with the sensitive information based on the labeling of the first audio data 184 with the fourth label 158. In response, the vishing defense system 100 may adjust the second audio data 186 to remove the sensitive information (e.g., the set of words associated with the sensitive information), thereby generating third audio data 188. For example, the vishing defense system 100 may replace the sensitive information with static noise to obfuscate the sensitive information. The third audio data 188 with the sensitive information removed, rather than the second audio data 186 that includes the sensitive information, may then be provided to the first caller device 180. Thus, the first caller device 180 does not receive the sensitive information. As discussed, a playout buffer or delay, such as 1000 milliseconds, may be implemented between provision of the second audio data 186 and receipt by the first caller device 180 to provide a sufficient amount of time for the vishing defense system 100 to analyze the second audio data 186 (e.g., to determine whether the second audio data 186 may include sensitive information) and/or modify the second audio data 186 (e.g., in response to determining the second audio data 186 includes sensitive information) to block receipt of sensitive information by the first caller device 180.

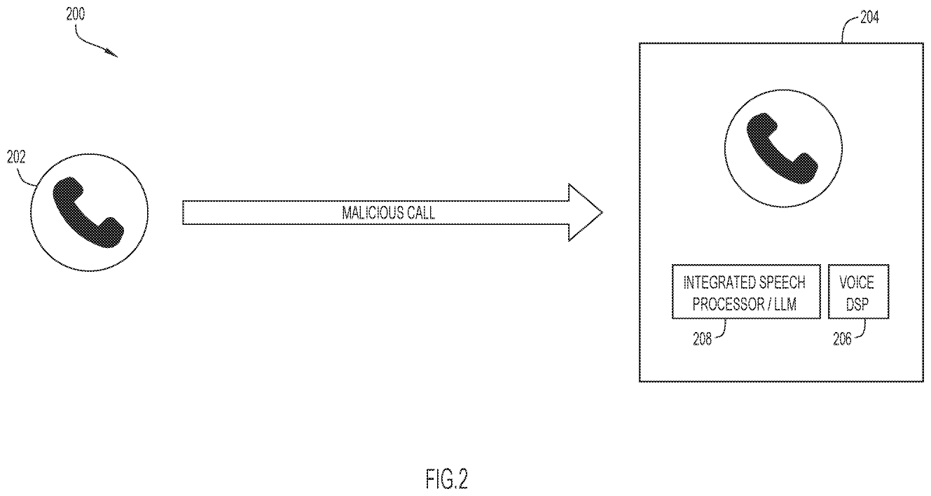

FIG. 2 is a schematic diagram of a vishing defense system 200. As illustrated, a first device 202 (e.g., a caller device) is connected to a second device 204 (e.g., a recipient device). The vishing defense system 200 may be implemented and integrated (e.g., embedded) in the second device 204. For example, the second device 204 may include a voice processor or processing circuitry 206 configured to process input audio data received from the first device 202 to provide processed data, such as text converted from audio data. The second device 204 may also include a speech processor or processing circuitry 208 configured to analyze speech using the processed data to perform various operations, such as those discussed with respect to the vishing defense system 100 of FIG. 1A. In additional or alternative embodiments, the voice processor 206 may be configured to perform at least some of the operations discussed with respect to the vishing defense system 100. In either case, the vishing defense system 200 may be integrated with the second device 204 such that the second device 204 is configured to receive the audio data, process and analyze the audio data, and perform a corresponding operation accordingly. In other words, the second device 204 may be configured to directly operate to detect and/or mitigate a potential vishing attack.

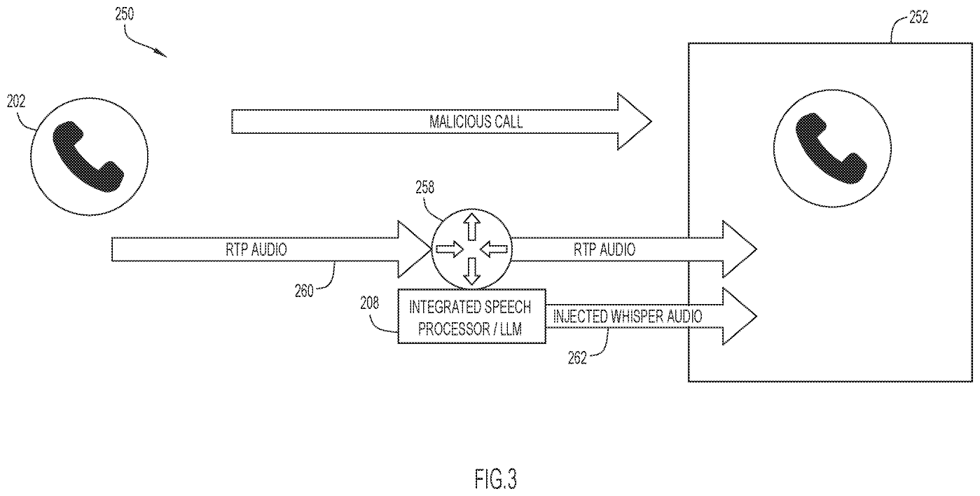

FIG. 3 is a schematic diagram of a vishing defense system 250. In the illustrated embodiment, a third device 252 (e.g., another recipient device) is connected to the first device 202. In certain embodiments, the third device 252 may not be configured to perform certain operations of the vishing defense system 250, such as those discussed with respect to the vishing defense system 100 of FIG. 1A. However, the third device 252 may be communicatively coupled to an intermediate device 258 (e.g., a conference node, a transcoder, a conference bridge) configured to perform such operations. That is, the processing circuitry 208 discussed with respect to FIG. 2 may be integrated in the intermediate device 258. By way of example, the intermediate device 258 may receive audio data 260 provided via the first device 202, and the intermediate device 258 may analyze the audio data 260, perform a corresponding operation, and forward the audio data 260 to the third device 252 for output to a user. In this way, audio data is provided sequentially between the first device 202, the third device 252, and the intermediate device 258. That is, the intermediate device 258 operates as an in-band audio termination by forcing a media termination point for the call session between the first device 202 and the third device 252.

Moreover, the intermediate device 258 may be configured to provide additional audio data and/or modify the audio data 260. As an example, in response to detecting the intent associated with the audio data 260 is a potential vishing attack, the intermediate device 258 may be configured to provide notification audio data 262 to inform the user of the third device 252 of a potential vishing attack. The notification audio data 262 may supplement or replace some of the audio data 260 provided via the first device 202. For instance, the notification audio data 262 may be delivered via a live call ‘whisper notification,’ which would include words generated by the LLM and converted to spoken audio, then mixed into the existing audio stream to be audible to the user of the third device 252 without being audible to the user of the first device 202. As another example, the intermediate device 258 may be configured to receive audio data via the third device 252 (e.g., audio data provided by the user of the third device 252), determine such audio data includes sensitive information (e.g., inadvertently provided as a result of a vishing attack), modify the audio data to remove the sensitive information being provided, and provide the modified audio data to the first device 202. That is, for instance, a portion of the audio data provided via the third device 252 having the sensitive information may be extracted and removed. As a result, the audio data received by the first device 202 may not have the sensitive information. In either example, the intermediate device 258 may intervene the exchange of audio data between the first device 202 and the third device 252 and selectively cause the first device 202 and/or the third device 252 to receive corresponding audio data based on a potential vishing attack or provision of sensitive information. However, it should be noted that the intermediate device 258 may also perform another suitable operation, such as to block audio data transmission from the first device 202 to the third device 252, to disconnect the call session, to lock a user account (e.g., of the user of the third device 252), and/or to block further calls from the first device 202.

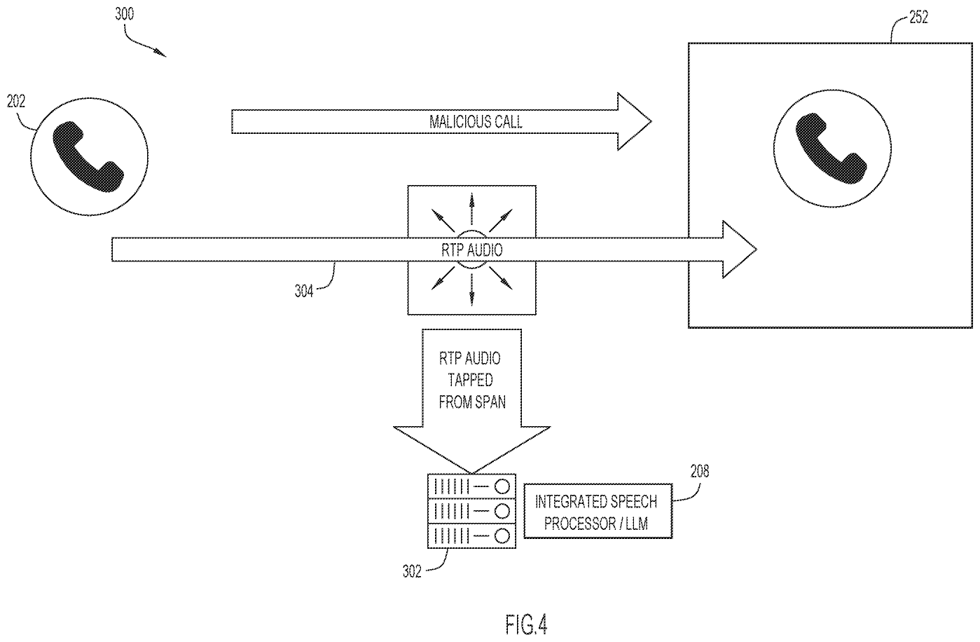

FIG. 4 is a schematic diagram of a vishing defense system 300. In the illustrated embodiment, audio data 304 is offloaded in parallel to a server 302 (e.g., a central server) for passive parallel packet capture of audio streams. That is, audio data 304 provided via the first device 202 may be received concurrently by the server 302 and by the third device 252. Additionally, audio data 304 provided via the third device 252 may be received concurrently by the server 302 and by the first device 202. The server 302 may include the processing circuitry 208 and may therefore be configured to perform various operations of the vishing defense system 300, such as those discussed with respect to the vishing defense system 100 of FIG. 1A. By way of example, the server 302 may disconnect a call session, lock a user account, and/or block further calls from the first device 202.

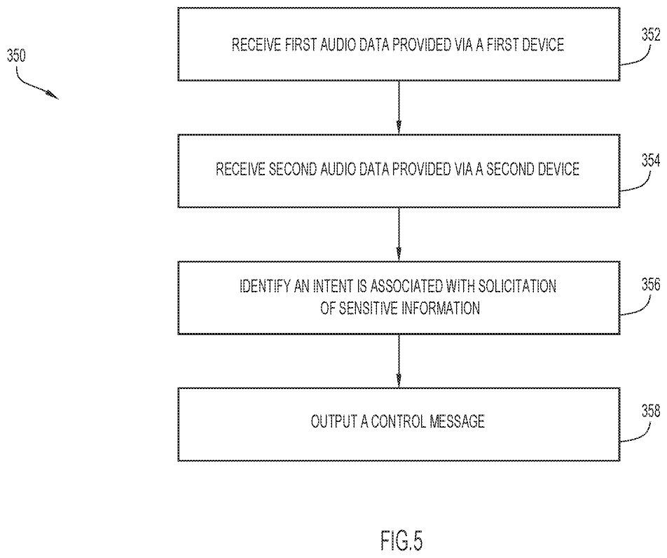

Each of FIGS. 5-8 discussed below illustrates a respective method of operation of a vishing defense system, such as any of the vishing defense systems discussed above. It should be noted that any of the methods may be performed in a different manner than depicted. For example, a step may not be performed, an additional step may be performed, and/or certain steps may be performed in a different order. Further, the steps of the same method and/or of different methods may be performed in any relation with one another, such as concurrently and/or sequentially with one another. Further still, the steps of any of the methods may be repeatedly performed.

FIG. 5 is a flowchart of an embodiment of a method 350 for operating based on analyzed audio data exchanged between devices during a call session. At step 352, first audio data provided via a first device (e.g., a first phone, a first computer, a first tablet) may be received. At step 354, second audio data provided via a second device (e.g., a second phone, a second computer, a second tablet) may be received. For example, each of the first audio data and the second audio data may include speech provided by respective users of the first device and the second device.

The first audio data and the second audio data may then be analyzed to determine a content of the first audio data and of the second audio data, such as a conversation topic. In some embodiments, one or more LLMs may be used to analyze the first audio data and the second audio data. By way of example, the LLMs may identify sets of words that signify intent of a vishing attack in the first audio data and in the second audio data, query a database storing datasets that associate strings of words with corresponding intents, and select the intent associated with the content according to the datasets. The use of LLMs may enable the method 350 to be readily performed, such as without having to initially operate to generate training data for subsequent reference during operations to identify a vishing attack. At step 356, an intent associated with solicitation of sensitive information may be identified. At step 358, a control message may be output in response to mitigate or address such an intent.

In some embodiments, the control message may be used to modify subsequent audio data provided via the first device and/or via the second device. As an example, the control message may block exchange of audio data that includes the sensitive information intended to be solicited, such as by removing at least a portion of subsequent audio data provided via the first device and/or via the second device. As another example, the control message may additionally or alternatively include an audio notification, or any other suitable notification that would discourage a user from providing sensitive information. Additionally or alternatively, the control message may be used to modify or lock a user account. For instance, a determination may be made that the sensitive information relates to the user account (e.g., login credentials, account information). Thus, the control message may change the user account to block such sensitive information from affecting the user account. For example, the control message may block access to the user account for a duration of time and/or to change (e.g., reset) the login credentials of the user account to prevent or discourage access/usage of the sensitive information. In further embodiments, the control message may try to authenticate the user having the intent associated with solicitation of sensitive information. Such authentication may further indicate whether the user is to receive the sensitive information (e.g., as opposed to the user is impersonating another entity to manipulate improper receipt of the sensitive information). Further still, the control message may disconnect the call session and/or transfer one of the devices (e.g., to communicatively couple to law enforcement) to generate a different call session that may address the intent associated with solicitation of sensitive information.

In certain embodiments, a particular control message may be selectively output. As an example, a score measuring the severity of the solicitation of sensitive information may be determined, and the control message may be selected based on the score. For instance, a first control message may be selected based on the score being below a first threshold (e.g., for a relatively low score), a second control message may be selected based on the score being between a first threshold and a second threshold (e.g., for an intermediate score), and a third control message may be selected based on the score being above the second threshold (e.g., for a high score). As another example, a control message may be selected based on how the intent associated with solicitation of sensitive information was identified. For instance, a control message (e.g., to provide an audio notification) that prevents or discourages provision of sensitive information may be output in response to identifying the intent before determining sensitive information was actually provided to a user, a control message (e.g., to censor sensitive information) that intervenes audio data exchange may be output in response to identifying the intent based on determining sensitive information was provided but has not yet been received by a user, and a control message (e.g., to disconnect a call session, to modify a user account) that reduces effects of the provision of the sensitive information may be output in response to identifying the intent based on determining sensitive information was already received by a user. In either case, selectively outputting a control message may provide a more suitable way of addressing the intent associated with solicitation of sensitive information.

The score may also be stored for analyzing trends related to vishing attacks, such as to identify users that may be more susceptible to receiving vishing attacks associated with higher scores, to identify geographic locations from which vishing attacks associated with higher scores may originate, and/or to identify times (e.g., months of a calendar year) during which vishing attacks associated with higher scores may occur. An operation may then be performed based on such analysis of trends, such as to provide more training to certain users and/or to adjust the LLM(s) used to identify the intent associated with solicitation of sensitive information (e.g., by adjusting the threshold for identifying the intent associated with solicitation of sensitive information based on calls received from certain geographic locations and/or at certain times).

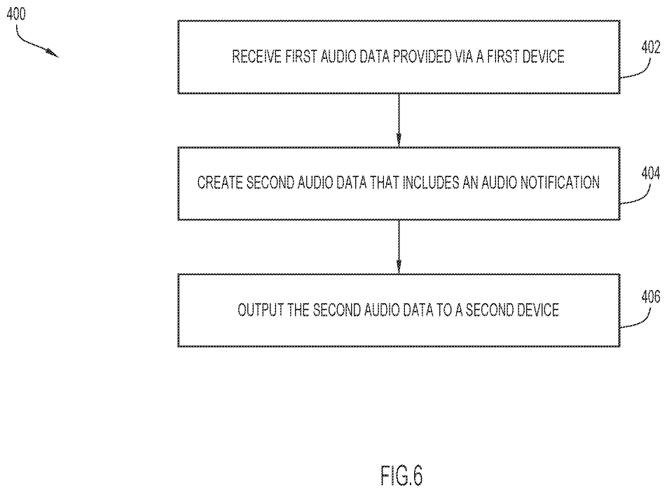

FIG. 6 is a flowchart of an embodiment of a method 400 for adjusting audio data to address a potential vishing attack performed by a user of a first device (e.g., a first phone, a first computer, a first tablet). At step 402, first audio data provided via the first device may be received. At step 404, second audio data that includes an audio notification may be created. At step 406, the second audio data may be output to a second device (e.g., a second phone, a second computer, a second tablet). As a result, the second audio data may be provided to a user of the second device and may inform the user of the potential vishing attack. Consequently, the user may be cautious and discouraged from providing any sensitive information. The second audio data may be set at a volume that enables the user of the second device to perceive the second audio data (e.g., in addition to the first audio data) without being audible to the user of the first device, thereby notifying the user of the second device without raising suspicion of the user of the first device. In some embodiments, the first audio data may be modified to include the second audio data. That is, the second audio data may replace a part of the first audio data. In additional or alternative embodiments, the second audio data may overlay the first audio data. That is, each of the first audio data and the second audio data may be provided to the user of the second device.

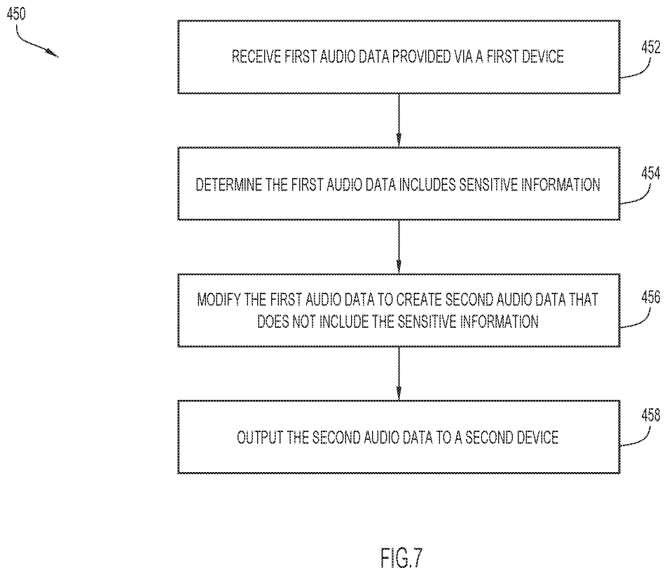

FIG. 7 is a flowchart of an embodiment of another method 450 for adjusting audio data to address a potential vishing attack. At step 452, first audio data provided via a first device (e.g., a first phone, a first computer, a first tablet) may be received. At step 454, a determination may be made that the first audio data may include sensitive information. For example, the first audio data may be analyzed (e.g., via one or more LLM(s)) to identify an intent of a vishing attack in the first audio data, a database storing labeled datasets that associate various word sets with sensitive information may be queried, and the word sets in the first audio data may match that stored in the database to indicate inclusion of the sensitive information in the first audio data. In response, at step 456, the first audio data may be modified to create second audio data that does not include the sensitive information. That is, the portion of the first audio data containing the sensitive information may be removed to generate the second audio data that excludes the sensitive information. In this manner, the sensitive information may be censored. At step 458, the second audio data may be output to a second device (e.g., a second phone, a second computer, a second tablet) to provide the second audio data to a user of the second device. By removing the sensitive information from the first audio data, the sensitive information may not be provided to the user of the second device via the second audio data.

In certain embodiments, replacement audio data may be injected to substitute or mask the removed sensitive information. As an example, the replacement audio data may include false information that may be unimportant or unusable. For instance, the replacement audio data may be provided using an artificially generated voice that mimics the voice of the user of the first device, thereby providing a realistic voice that may convince the user of the second device that the false information is actually sensitive information. Thus, the user of the second device may be satisfied and may no longer try to solicit additional sensitive information during the call session.

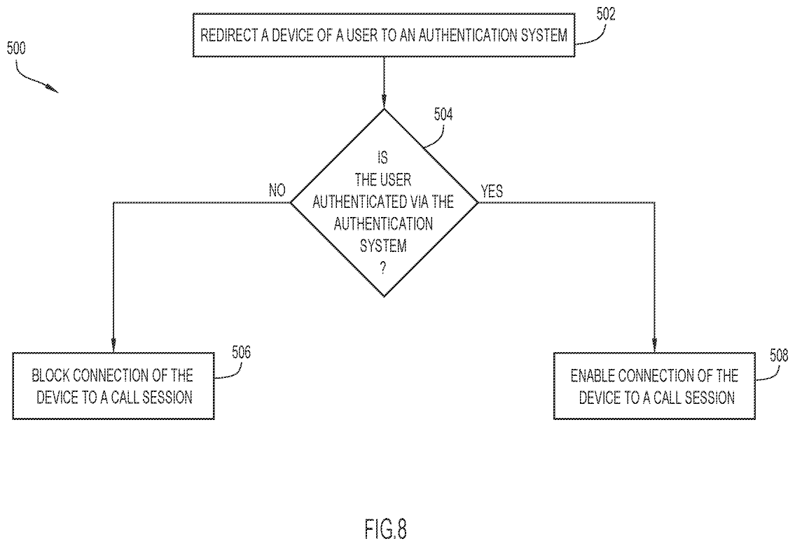

FIG. 8 is a flowchart of an embodiment of a method 500 for authenticating a user to address a potential vishing attack. At step 502, a device (e.g., a phone, a computer, a tablet) of a user may be redirected to an authentication system. For example, the device may be redirected in response to an identification that an intent of the user is associated with solicitation of sensitive information and/or in response to a determination that sensitive information is being provided to the user. Additionally or alternatively, the device may be redirected in response to a determination that the user indicates their identity. In further embodiments, the device may be redirected in response to a user input, such as that provided by the other user with which the user of the device is conversing during a call session. The authentication system may then operate to authenticate the user. That is, the authentication system may verify the identity of the user (e.g., as matching that indicated by the user).

In certain embodiments, properties of the voice of the user, such as tone, timbre, pitch, volume, rate, and so forth, may be determined (e.g., from audio provided via the device of the user) and compared to expected or known voice properties associated with an indicated identity. For instance, the authentication system may initially operate in a calibration mode in which the actual user of the identity enrolls their voice into the authentication system, such as by providing a voice sample (e.g., speaking predetermined words) with multi-factor authentication. Enrollment of the voice of the actual user may provide a dataset containing the expected or known voice properties associated with the identity that may be referenced during an authentication operation. A match between the determined voice properties and the expected voice properties may authenticate the user, whereas a mismatch between the determined voice properties and the expected voice properties (e.g., a difference between the determined voice properties and the expected voice properties is above a threshold) may result in inability to authenticate the user. In some cases, the voice may be generated using artificial intelligence (e.g., instead of being provided by a human). In such cases, a watermark may be included by the artificially generated voice. Such detection of the watermark may also result in an inability to authenticate the user (e.g., regardless of whether the determined voice properties match the expected voice properties).

In additional or alternative embodiments, the authentication system may try to authenticate the user utilizing a code. That is, the authentication system may transmit a code to an additional device that is associated with the indicated identity (e.g., as a result of enrollment of the additional device into the authentication system). The user may then be prompted to submit the code, and the user may be authenticated based on the user successfully submitting the transmitted code. However, based on an inability of the user to submit the transmitted code, which may indicate that the user is impersonating the identity and therefore does not have access to the additional device and is not able to retrieve the transmitted code, the user may not be authenticated.

In further embodiments, an identification of the device of the user may be determined and compared to a list of possible device identifications associated with the indicated identity (e.g., resulting from enrollment into the authentication system). A match between the identification of the device and one of the list of possible device identifications may authenticate the user, but a mismatch between the identification of the device and the list of possible device identifications may result in inability to authenticate the user.

At step 504, a determination is made whether the user is authenticated via the authentication system. At step 506, in response to a determination that the user is unauthenticated, a connection of the device to a call session may be blocked. That is, the device may be blocked from communicatively coupling with another device. For instance, the device may have been redirected from a call session with another device to the authentication system, and the device may be blocked from re-entering the call session to reconnect with the other device. Thus, a user of the device may be blocked from trying to solicit sensitive information from another user of the other device. However, at step 508, in response to a determination that the identity of the user has been authenticated, a connection of the device to a call session may be enabled. By way of example, the device may be redirected from the authentication system back to reconnect the other device of the call session.

Additionally or alternatively, another operation may be performed based on authentication of the user. For example, connection of the device of the user to a call session may be enabled, but audio provided by the device and/or provided toward the device may be modified (e.g., to remove sensitive information that otherwise may be provided to the user). As such, even though connection of the device to the call session may be enabled, an additional operation to address or mitigate exchange of sensitive information may be performed based on an inability to authenticate the user.

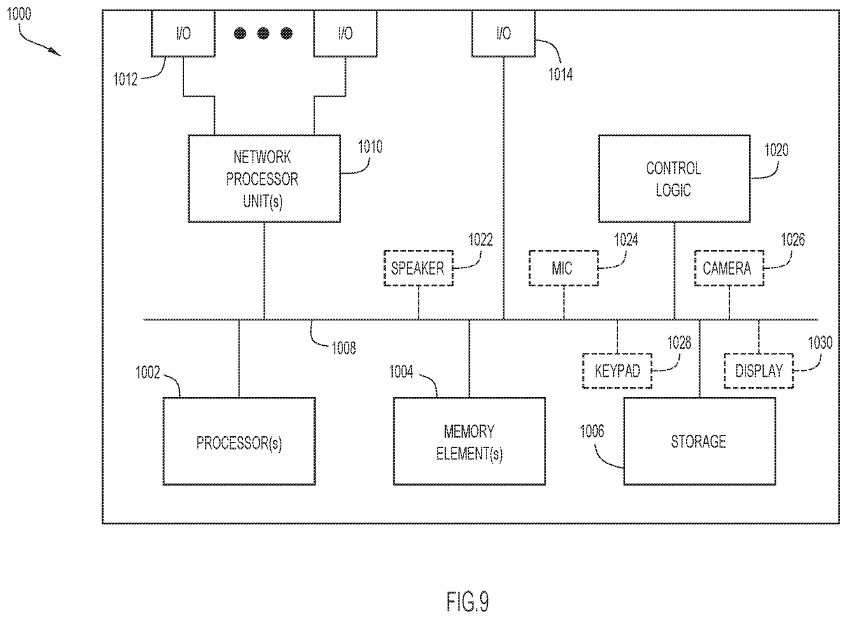

FIG. 9 illustrates a hardware block diagram of a computing/computer device 1000 that may perform functions of a server device associated with operations discussed herein. In various embodiments, a computing device, such as computing device 1000 or any combination of computing devices 1000, may be configured as any devices as discussed for the techniques depicted herein in order to perform operations of the various techniques discussed herein.

In at least one embodiment, the computing device 1000 may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and server logic 1020. In various embodiments, instructions associated with logic for the computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, a physical layer (PHY), controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., server logic 1020) can, in various embodiments, be stored for computing device 1000 using any combination of memory element(s) 1004 and/or storage 1006. Note that in some embodiments, storage 1006 can be consolidated with memory element(s) 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input and/or output device now known or hereafter developed. This may be the case, in particular, when the computing device 1000 serves as a user device described herein. In some instances, external devices can also include portable computer-readable (non-transitory) storage media such as database systems, thumb drives, portable optical or magnetic disks, and memory cards. In still some instances, external devices can be a mechanism to display data to a user, such as, for example, a computer monitor and/or a display screen, particularly when the computing device 1000 serves as a user device as described herein.

With respect to certain entities (e.g., computer device, endpoint device, user device, agent device, etc.), the computing device 1000 may further include, or be coupled to, an audio speaker 1022 to convey sound, microphone or other sound sensing device 1024, a camera or image capture device 1026, a keypad or keyboard 1028 to enter information (e.g., alphanumeric information, etc.), and/or a touch screen or other display 1030. These items may be coupled to the bus 1008 or to the I/O interface(s) 1014 to transfer data with other elements of the computing device 1000.

In various embodiments, server logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein. In various embodiments, instructions associated with the server logic 1020 are configured to perform the server operations described herein, including those depicted by the flow chart for the methods 350, 400, 450, 500.

The programs and software described herein (e.g., server logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.) and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, Wide Area Network (WAN), Intranet, Internet, hardwire, modem connection, wireless, etc.). For example, the functions of the present embodiments may be distributed in any manner among the various end-user/client, server, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer-readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer-useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer-readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer-readable storage medium.

In some aspects, the techniques described herein relate to a method including: receiving first audio data provided via a first device of a first user during a call session between the first device and a second device of a second user; receiving second audio data provided via the second device during the call session; providing the first audio data and/or the second audio data to a large language model (LLM) to determine an intent of the first user; and transmitting a control message in response to determining the intent of the first user is associated with soliciting sensitive information from the second user.

In some aspects, the techniques described herein relate to a method, further including: transmitting the control message to modify the first audio data to create third audio data that includes an audio notification; and outputting the third audio data to the second device to provide the third audio data to the second user during the call session.

In some aspects, the techniques described herein relate to a method, wherein modifying the first audio data includes: removing at least a portion of the first audio data to block output of the at least a portion of the first audio data via the second device to the second user; and replacing the at least a portion of the first audio data with the third audio data.

In some aspects, the techniques described herein relate to a method, wherein modifying the first audio data includes overlaying the audio notification on the first audio data.

In some aspects, the techniques described herein relate to a method, further including: determining the second audio data includes the sensitive information; transmitting the control message to modify the second audio data to create third audio data that excludes the sensitive information; and transmitting the third audio data to the first device to provide the third audio data to the first user during the call session.

In some aspects, the techniques described herein relate to a method, further including: determining the second audio data includes the sensitive information; identifying a user account associated with the sensitive information; and transmitting the control message to modify the user account.

In some aspects, the techniques described herein relate to a method, wherein transmitting the control message to modify the user account includes locking the user account, modifying login credentials of the user account, or both.

In some aspects, the techniques described herein relate to a method, further including: transmitting the control message to redirect the first device from the second device to an authentication system; determining, via the authentication system, the first user is unauthenticated; and blocking reconnection between the first device and the second device in response to determining the first user is unauthenticated.

In some aspects, the techniques described herein relate to a method, further including updating the LLM based on a determination that the intent of the first user is associated with soliciting the sensitive information from the second user.

In some aspects, the techniques described herein relate to a non-transitory, computer-readable medium including instructions that, when executed by one or more processors, cause the one or more processors to perform operations including: analyzing audio data exchanged between a plurality of devices during a call session; identifying an intent associated with solicitation of sensitive information based on analysis of the audio data; and modifying the audio data in response to identifying the intent associated with solicitation of the sensitive information.

In some aspects, the techniques described herein relate to a non-transitory, computer-readable medium, wherein the instructions, when executed by the one or more processors, cause the one or more processors to perform operations including: identifying the intent associated with solicitation of the sensitive information by a user of a device of the plurality of devices; and modifying the audio data provided via the device and/or the audio data provided toward the device in response to identifying the intent associated with solicitation of the sensitive information by the user of the device.

In some aspects, the techniques described herein relate to a non-transitory, computer-readable medium, wherein the instructions, when executed by the one or more processors, cause the one or more processors to perform operations including: identifying the intent associated with solicitation of the sensitive information by identifying a portion of the audio data includes the sensitive information; modifying the audio data by removing the portion of the audio data to remove the sensitive information; and outputting the audio data with the sensitive information removed to a device of the plurality of devices.

In some aspects, the techniques described herein relate to a non-transitory, computer-readable medium, wherein the instructions, when executed by the one or more processors, cause the one or more processors to perform operations including: modifying the audio data by replacing the portion of the audio data with replacement audio data; and outputting the audio data that includes the replacement audio data to the device of the plurality of devices.

In some aspects, the techniques described herein relate to a non-transitory, computer-readable medium, wherein the instructions, when executed by the one or more processors, cause the one or more processors to perform operations including: modifying the audio data by overlaying with additional audio data; and outputting the additional audio data to a device of the plurality of devices.

In some aspects, the techniques described herein relate to a non-transitory, computer-readable medium, wherein the instructions, when executed by the one or more processors, cause the one or more processors to perform operations including: attempting to authenticate a user of a device of the plurality of devices in response to identifying the intent associated with solicitation of the sensitive information based on analysis of the audio data; and modifying the audio data provided via the device of the plurality of devices in response to determining the user is unauthenticated.

In some aspects, the techniques described herein relate to an apparatus including: one or more processors; and a memory communicatively coupled to the one or more processors, wherein the memory includes instructions that, when executed by the one or more processors, cause the one or more processors to perform operations including: analyzing first audio data provided via a first device and second audio data provided via a second device during a call session between the first device and the second device; identifying an intent of a first user of the first device is associated with soliciting sensitive information from a second user of the second device; and modifying the first audio data and/or the second audio data in response to identifying the intent of the first user is associated with soliciting sensitive information from the second user.

In some aspects, the techniques described herein relate to an apparatus, wherein the instructions, when executed by the one or more processors, cause the one or more processors to perform operations including transmitting third audio data to the second device in response to identifying the intent of the first user is associated with soliciting sensitive information from the second user.

In some aspects, the techniques described herein relate to an apparatus, wherein the instructions, when executed by the one or more processors, cause the one or more processors to perform operations including: receiving the first audio data provided via the first device for forwarding to the second device; and receiving the second audio data provided via the second device for forwarding to the first device.

In some aspects, the techniques described herein relate to an apparatus, wherein the instructions, when executed by the one or more processors, cause the one or more processors to perform operations including: receiving the first audio data provided via the first device in parallel with the second device; and receiving the second audio data provided via the second device in parallel with the first device.

In some aspects, the techniques described herein relate to an apparatus, including the second device, wherein the second device includes the one or more processors and the memory.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any LAN, virtual LAN (VLAN), WAN (e.g., the Internet), software defined WAN (SD-WAN), wireless local area (WLA) access network, wireless wide area (WWA) access network, metropolitan area network (MAN), Intranet, Extranet, VPN, Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein.

Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are include′ in one or more embodiment's of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving first audio data provided via a first device of a first user during a call session between the first device and a second device of a second user;
receiving second audio data provided via the second device during the call session;
providing the first audio data and/or the second audio data to a large language model (LLM) to determine an intent of the first user; and
transmitting a control message in response to determining the intent of the first user is associated with soliciting sensitive information from the second user.

2. The method of claim 1, further comprising:
transmitting the control message to modify the first audio data to create third audio data that includes an audio notification; and
outputting the third audio data to the second device to provide the third audio data to the second user during the call session.

3. The method of claim 1, further comprising recording additional audio data provided via the first device and/or via the second device in response to determining the intent of the first user is associated with soliciting sensitive information from the second user.

4. The method of claim 1, further comprising:
determining a score related to the intent of the first user associated with soliciting sensitive information from the second user and/or related to a severity of solicitation of the sensitive information;
comparing the score to a threshold; and
transmitting the control message based on comparison of the score to the threshold.

5. The method of claim 1, further comprising:
determining the second audio data includes the sensitive information;
transmitting the control message to modify the second audio data to create third audio data that excludes the sensitive information; and
transmitting the third audio data to the first device to provide the third audio data to the first user during the call session.

6. The method of claim 1, further comprising:
determining the second audio data includes the sensitive information;
identifying a user account associated with the sensitive information; and
transmitting the control message to modify the user account.

7. The method of claim 6, wherein transmitting the control message to modify the user account comprises locking the user account, modifying login credentials of the user account, or both.

8. The method of claim 1, further comprising:
transmitting the control message to redirect the first device from the second device to an authentication system;
determining, via the authentication system, the first user is unauthenticated; and
blocking reconnection between the first device and the second device in response to determining the first user is unauthenticated.

9. The method of claim 1, further comprising updating the LLM based on a determination that the intent of the first user is associated with soliciting the sensitive information from the second user.

10. A non-transitory, computer-readable medium comprising instructions that, when executed by one or more processors, cause the one or more processors to perform operations comprising:
analyzing audio data exchanged between a plurality of devices during a call session;
identifying an intent associated with solicitation of sensitive information based on analysis of the audio data; and
modifying the audio data in response to identifying the intent associated with solicitation of the sensitive information.

11. The non-transitory, computer-readable medium of claim 10, wherein the instructions, when executed by the one or more processors, cause the one or more processors to perform operations comprising:
identifying the intent associated with solicitation of the sensitive information by a user of a device of the plurality of devices; and
modifying the audio data provided via the device and/or the audio data provided toward the device in response to identifying the intent associated with solicitation of the sensitive information by the user of the device.

12. The non-transitory, computer-readable medium of claim 10, wherein the instructions, when executed by the one or more processors, cause the one or more processors to perform operations comprising:
identifying the intent associated with solicitation of the sensitive information by identifying a portion of the audio data comprises the sensitive information;
modifying the audio data by removing the portion of the audio data to remove the sensitive information; and
outputting the audio data with the sensitive information removed to a device of the plurality of devices.

13. The non-transitory, computer-readable medium of claim 12, wherein the instructions, when executed by the one or more processors, cause the one or more processors to perform operations comprising:
modifying the audio data by replacing the portion of the audio data with replacement audio data; and
outputting the audio data that includes the replacement audio data to the device of the plurality of devices.

14. The non-transitory, computer-readable medium of claim 10, wherein the instructions, when executed by the one or more processors, cause the one or more processors to perform operations comprising:
modifying the audio data by overlaying with additional audio data; and
outputting the additional audio data to a device of the plurality of devices.

15. The non-transitory, computer-readable medium of claim 10, wherein the instructions, when executed by the one or more processors, cause the one or more processors to perform operations comprising:
attempting to authenticate a user of a device of the plurality of devices in response to identifying the intent associated with solicitation of the sensitive information based on analysis of the audio data; and
modifying the audio data provided via the device of the plurality of devices in response to determining the user is unauthenticated.

16. An apparatus comprising:
one or more processors; and
a memory communicatively coupled to the one or more processors, wherein the memory comprises instructions that, when executed by the one or more processors, cause the one or more processors to perform operations comprising:
analyzing first audio data provided via a first device and second audio data provided via a second device during a call session between the first device and the second device;
identifying an intent of a first user of the first device is associated with soliciting sensitive information from a second user of the second device; and
modifying the first audio data and/or the second audio data in response to identifying the intent of the first user is associated with soliciting sensitive information from the second user.

17. The apparatus of claim 16, wherein the instructions, when executed by the one or more processors, cause the one or more processors to perform operations comprising transmitting third audio data to the second device in response to identifying the intent of the first user is associated with soliciting sensitive information from the second user.

18. The apparatus of claim 16, wherein the instructions, when executed by the one or more processors, cause the one or more processors to perform operations comprising:
receiving the first audio data provided via the first device for forwarding to the second device; and
receiving the second audio data provided via the second device for forwarding to the first device.

19. The apparatus of claim 16, wherein the instructions, when executed by the one or more processors, cause the one or more processors to perform operations comprising:
receiving the first audio data provided via the first device in parallel with the second device; and
receiving the second audio data provided via the second device in parallel with the first device.

20. The apparatus of claim 16, comprising the second device, wherein the second device comprises the one or more processors and the memory.
